(19) United States
(12) Patent Application Publication
(10) Pub. No.: US 2026/0008896 A1
(43) Pub. Date: Jan. 8, 2026

(54) REVERSIBLE CROSSLINKED FOAM ARTICLE AND PROCESS

(71) Applicant: Dow Global Technologies LLC, Midland, MI (US)

(72) Inventors: Bo Lyu, Shanghai (CN); Colin Li Pi Shan, Pearland, TX (US); Yabin Sun, Shanghai (CN); Hayley A. Brown, Houson, TX (US); Ryan Hall, Missouri City, TX (US); Gaoxiang Wu, Houston, TX (US)

(21) Appl. No.: 18/992,462

(22) PCT Filed: Jul. 14, 2023
(86) PCT No.: PCT/CN2023/107514

§ 371 Date: Jan. 8, 2025

Related U.S. Application Data
(60) Provisional application No. 63/389,707, filed on Jul. 15, 2022.
(60) Provisional application No. 63/389,738, filed on Jul. 15, 2022.

(51) Int. Cl. C08J 11/06; C08J 9/06; C08J 9/12

(52) U.S. Cl. CPC C08J 11/06; C08J 9/06; C08J 9/12; C08J 2353/00; C08J 2367/04; C08J 2481/04

(57) ABSTRACT

The present disclosure is directed to a foam article. In an embodiment, the foam article includes a crosslinked foam composition formed from starting materials comprising (i) a polymer selected from the group consisting of an ethylene-based polymer, a polar ethylene-based polymer, and combinations thereof, and (ii) 2, 2, 6, 6-tetramethyl-4-piperidyl methacrylate disulfide (BiTEMPS) methacrylate. This yields a foam article that is composed of a crosslinked composition comprising (i) the polymer selected from the group consisting of the ethylene-based polymer, the polar ethylene-based polymer, and combinations thereof, and (ii) linkages having a Structure (2) below

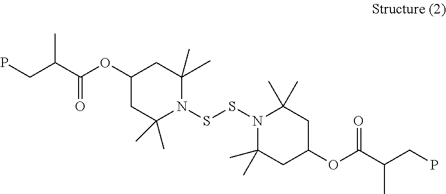

### BACKGROUND

Polyolefin elastomer foams are widely used in consumer applications such as footwear midsole. Crosslinking can increase the polymer skeleton viscosity which is favored in the foaming process and provides enhanced mechanical properties to the resultant foam. Conventional crosslinking is typically induced by the free radical process (peroxide) or irradiation for the formation of C—C bonds. Conventional crosslinked foam is very stable and cannot be further dissociated by heating or mechanical shearing. Therefore, the recyclability and/or the re-useability of foam articles that are conventionally crosslinked is very limited, or non-existent.

Given the global focus on carbon neutrality and recyclability of plastic materials, the art recognizes the need for crosslinked foam articles that can be reprocessed and/or recycled.

### SUMMARY

The present disclosure is directed to a foam article. In an embodiment, the foam article includes a crosslinked foam composition formed from starting materials comprising (i) a polymer selected from the group consisting of an ethylene-based polymer, a polar ethylene-based polymer, and combinations thereof, and (ii) 2,2,6,6-tetramethyl-4-piperidyl methacrylate disulfide (BiTEMPS) methacrylate. This yields a foam article that is composed of a crosslinked composition comprising (i) the polymer selected from the group consisting of the ethylene-based polymer, the polar ethylene-based polymer, and combinations thereof, and (ii) linkages having a Structure (2) below

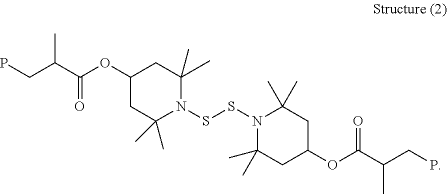

The present disclosure provides a process. In an embodiment, the process includes heating a foam article to a reprocessing temperature, the foam article composed of a crosslinked composition comprising (i) a polymer selected from the group consisting of an ethylene-based polymer, a polar ethylene-based polymer and combinations thereof; and
(ii) linkages having a Structure (2))

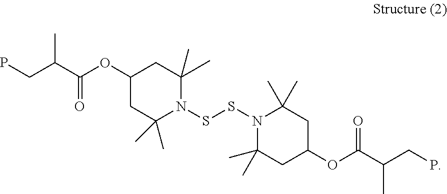

The foam article is formed from starting materials comprising (i) the polymer selected from the group consisting of an ethylene-based polymer, a polar ethylene-based polymer and combinations thereof and (ii) 2,2,6,6-tetramethyl-4-piperidyl methacrylate disulfide (BiTEMPS) methacrylate. The process include forming, at the reprocessing temperature, the foam article into a re-processable polymer composition. The process includes shaping, at the reprocessing temperature, the re-processable polymer composition into a re-processed pre-form. The process includes cooling the re-processed pre-form to below the reprocessing temperature and forming a second article composed of a re-crosslinked polymer composition composed of (i) the polymer selected from the group consisting of an ethylene-based polymer, a polar ethylene-based polymer and combinations thereof, and (ii) linkages having the Structure (2).

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

A “blowing agent” is a substance that is capable of producing a cellular structure in the composition via a foaming process.

The term “block copolymer” or “segmented copolymer” refers to a polymer comprising two or more chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. In an embodiment, the blocks differ in the amount or type of comonomer incorporated therein, the density, the amount of crystallinity, the type of crystallinity (e.g. polyethylene versus polypropylene), the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property. The block copolymers are characterized by unique distributions of both polymer polydispersity (PDI or Mw/Mn) and block length distribution, due to the effect of shuttling agent(s) in combination with the catalyst(s) employed in their preparation.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step, or procedure, whether or not the same is specifically disclosed. To avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains more than 50 mol % polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

“Ethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer. Ethylene plastomers/elastomers have a density from 0.854 g/cc to 0.920 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available from LG Chem Ltd.).

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from 0.940 g/cc, or 0.945 g/cc, or 0.950 g/cc, or 0.953 g/cc to 0.955 g/cc, or 0.960 g/cc, or 0.965 g/cc, or 0.970 g/cc, or 0.975 g/cc, or 0.980 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

The term “linear low density polyethylene,” (or “LLDPE”) as used herein, refers to a linear ethylene/α-olefin copolymer containing heterogeneous short-chain branching distribution comprising units derived from ethylene and units derived from at least one C₃-C₁₀ α-olefin, or C₄-C₈ α-olefin comonomer. LLDPE is characterized by little, if any, long chain branching, in contrast to conventional LDPE. LLDPE has a density from 0.910 g/cc to less than 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

The term “low density polyethylene” (or “LDPE”) may also be referred to as “high pressure ethylene polymer” or “highly branched polyethylene” and is an ethylene homopolymer and is typically produced by way of high pressure free radical polymerization ((≥100 MPa (for example, 100-400 MPa), tubular reactor or autoclave reactor with free radical initiator). LDPE resins typically have a density in the range of 0.915 to less than 0.940 g/cc. LDPE is distinct from LLDPE.

A “foam composition” (or “foam”) is a polymeric composition with a cellular structure. In other words, in its native state and prior to contact with the blowing agent, the polymeric composition is void of a cellular structure, and after contact with the blowing agent and depressurization, the polymeric composition is a foam composition with a cellular structure. The cells may be open cells, closed cells, or combinations thereof. In an embodiment, the cells have a uniform, or substantially uniform, cell size.

An “olefin-based polymer,” or “polyolefin,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains more than 50 weight percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably.

### Test Methods

Asker C Hardness of foam compositions was measured in accordance with ASTM D2240 on plaques with the dimensions 20 cm (length)×10 cm (width)×1-2 cm (thickness). One sample was tested for each example. Each sample was measured at least three times (with a 5 second latency between each measurement), across the surface of the sample (i.e., different positions along the sample). The average was recorded.

Compression Set (C-Set) was measured per ASTM D395 method B under conditions of 50% compression at 50° C. for 6 hours. Two cylindrical foam samples with 29 mm (±0.5 mm) in diameter and approximately 19.5 mm (±0.5 mm) thickness commonly referred to as “buttons” were tested per foam sample and the average was reported.

Density is measured in accordance with ASTM D792 with results reported in g/cc at 25° C.

Dynamic mechanical analysis (DMA). DMA experiments are conducted using a TA Instruments RSA-G2 Solid Analyzer to measure the storage modulus (G′), loss modulus (G″), and damping ratio (tan δ) of networks as a function of temperature and recycling under a nitrogen atmosphere. DMA is operated in tension mode at a frequency of 1 Hz with a 0.03% oscillatory strain. Data is collected from room temperature to 160° C. with a heating rate of 3° C./minute.

Falling Ball Rebound (Skin and Foam). A steel ball of ⅝″ diameter was dropped from a height of 500 mm onto the bun foam skin and foam layers (before and after aging) to determine the %-Rebound or Resilience. The %-Rebound is calculated as rebound height (mm)*100/500.

Melt index (MI or I₂) (for ethylene-based polymers) is measured in accordance with ASTM D 1238, Condition 190° C./2.16 kg with results reported in grams per 10 minutes (g/10 min).

### DETAILED DESCRIPTION

The present disclosure provides a foam article. In an embodiment, the foam article includes a crosslinked foam composition. The crosslinked foam composition is formed from starting materials comprising of a polymer selected an ethylene-based polymer, a polar ethylene-based polymer and combinations thereof; and 2,2,6,6-tetramethyl-4-piperidyl methacrylate disulfide (BiTEMPS) methacrylate.

### A. Ethylene-Based Polymer

The crosslinked foam composition is formed from a crosslinkable polymer composition (interchangeably referred to as “starting materials”). The crosslinkable polymer composition includes an ethylene-based polymer and/or a polar ethylene-based polymer. The ethylene-based polymer can be an ethylene homopolymer, an ethylene/C₃-C₁₀ α-olefin copolymer, or an ethylene C₄-C₈ α-olefin copolymer. The ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of suitable ethylene-based polymer include ethylene plastomer/elastomer, high density polyethylene (HDPE), linear low density polyethylene (LLDPE), low density polyethylene (LDPE), ethylene/α-olefin multi-block copolymer, and combinations thereof.

In an embodiment, the ethylene-based polymer is an ethylene plastomer/elastomer.

In an embodiment, the ethylene-based polymer is HDPE.

In an embodiment, the ethylene-based polymer is LLDPE.

In an embodiment, the ethylene-based polymer is LDPE.

In an embodiment, the ethylene-based polymer is an ethylene/α-olefin multi-block copolymer. The term “ethylene/α-olefin multi-block copolymer” refers to an ethylene/C₄-C₅ α-olefin multi-block copolymer consisting of ethylene and one copolymerizable C₄-C₅ α-olefin comonomer in polymerized form (and optional additives), the polymer characterized by multiple blocks or segments of two polymerized monomer units differing in chemical or physical properties, the blocks joined (or covalently bonded) in a linear manner, that is, a polymer comprising chemically differentiated units which are joined end-to-end with respect to polymerized ethylenic functionality. Ethylene/α-olefin multi-block copolymer includes block copolymer with two blocks (di-block) and more than two blocks (multi-block). The C₄-C₈ α-olefin is selected from butene, hexene, and octene. The ethylene/α-olefin multi-block copolymer is void of, or otherwise excludes, styrene (i.e., is styrene-free), and/or vinyl aromatic monomer, and/or conjugated diene. When referring to amounts of “ethylene” or “comonomer” in the copolymer, it is understood that this refers to polymerized units thereof. In some embodiments, the ethylene/α-olefin multi-block copolymer can be represented by the following formula: (AB)ₙ; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/α-olefin multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

In an embodiment, ethylene comprises the majority mole fraction of the whole ethylene/α-olefin multi-block copolymer, i.e., ethylene comprises at least 50 wt % of the whole ethylene/α-olefin multi-block copolymer. More preferably, ethylene comprises at least 60 wt %, at least 70 wt %, or at least 80 wt %, with the substantial remainder of the whole ethylene/α-olefin multi-block copolymer comprising the C₄-C₈ α-olefin comonomer. In an embodiment, the ethylene/α-olefin multi-block copolymer contains 50 wt % to 90 wt % ethylene, or 60 wt % to 85 wt % ethylene, or 65 wt % to 80 wt % ethylene. For many ethylene/octene multi-block copolymers, the composition comprises an ethylene content greater than 80 wt % of the whole ethylene/octene multi-block copolymer and an octene content of from 10 wt % to 15 wt %, or from 15 wt % to 20 wt % of the whole multi-block copolymer.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, greater than 10 wt %, or greater than 15 wt %, based on the weight of the polymer. In an embodiment, the comonomer content in the soft segments is greater than 20 wt %, greater than 25 wt %, greater than 30 wt %, greater than 35 wt %, greater than 40 wt %, greater than 45 wt %, greater than 50 wt %, or greater than 60 wt % and can be up to 100 wt %.

The soft segments can be present in an ethylene/α-olefin multi-block copolymer from 1 wt % to 99 wt % of the total weight of the ethylene/α-olefin multi-block copolymer, or from 5 wt % to 95 wt %, from 10 wt % to 90 wt %, from 15 wt % to 85 wt %, from 20 wt % to 80 wt %, from 25 wt % to 75 wt %, from 30 wt % to 70 wt %, from 35 wt % to 65 wt %, from 40 wt % to 60 wt %, or from 45 wt % to 55 wt % of the total weight of the ethylene/α-olefin multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, entitled “Ethylene/α-Olefin Block Inter-Polymers,” filed on Mar. 15, 2006, in the name of Colin L. P. Shan, Lonnie Hazlitt, et. al. and assigned to Dow Global Technologies Inc., the disclosure of which is incorporated by reference herein in its entirety. In particular, hard and soft segment weight percentages and comonomer content may be determined as described in column 57 to column 63 of U.S. Pat. No. 7,608,668.

The ethylene/α-olefin multi-block copolymer comprises two or more chemically distinct regions or segments (referred to as “blocks”) joined (or covalently bonded) in a linear manner, that is, it contains chemically differentiated units which are joined end-to-end with respect to polymerized ethylenic functionality, rather than in pendent or grafted fashion. In an embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/α-olefin multi-block copolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

In an embodiment, the ethylene/α-olefin multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/α-olefin multi-block copolymer possesses Mw/Mn from 1.0 to 3.5, or from 1.3 to 3, or from 1.4 to 2.5, or from 1.4 to 2.

In addition, the ethylene/α-olefin multi-block copolymer possesses a PDI (or Mw/Mn) fitting a Schultz-Flory distribution rather than a Poisson distribution. The present ethylene/α-olefin multi-block copolymer has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phys. (1997) 107 (21), pp 9234-9238.

In an embodiment, the present ethylene/α-olefin multi-block copolymer possesses a most probable distribution of block lengths.

In a further embodiment, the ethylene/α-olefin multi-block copolymer of the present disclosure, especially those made in a continuous, solution polymerization reactor, possess a most probable distribution of block lengths. In one embodiment of this disclosure, ethylene/α-olefin multi-block copolymers are defined as having:
(A) Mw/Mn from about 1.7 to about 3.5, at least one melting point, Tm, in degrees Celsius, and a density, d, in grams/cubic centimeter, wherein the numerical values of Tm and d correspond to the relationship:

$$Tm > - 2002.9 + 4 538.5 ( d ) - 2422.2 {( d )}^{2} ,$$

(B) Mw/Mn from about 1.7 to about 3.5, and is characterized by a heat of fusion, DH in J/g, and a delta quantity, DT, in degrees Celsius defined as the temperature difference between the tallest DSC peak and the tallest Crystallization Analysis Fractionation (“CRYSTAF”) peak, wherein the numerical values of DT and DH have the following relationships:

$$DT > - 0.1299 DH + 62.8 1 for DH greater than zero and up to 130 J / g$$

$$DT \geq 48 ° C . for DH greater than 130 J / g$$

wherein the CRYSTAF peak is determined using at least 5 percent of the cumulative polymer, and if less than 5 percent of the polymer has an identifiable CRYSTAF peak, then the CRYSTAF temperature is 30° C.; and/or
(C) elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/α-olefin interpolymer is substantially free of crosslinked phase:

$$Re > 1481 - 1629 ( d ) ;$$

and/or
(D) has a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density and molar comonomer content (based on the whole polymer) within 10 percent of that of the ethylene/α-olefin interpolymer; and/or
(E) has a storage modulus at 25° C., G′(25° C.), and a storage modulus at 100° C., G′(100° C.), wherein the ratio of G′(25° C.) to G′(100° C.) is in the range of 1:1 to 9:1.

The ethylene/α-olefin multi-block copolymer may also have:
(F) a molecular fraction which elutes between 40° C. and 130° C. when fractionated using TREF, characterized in that the fraction has a block index of at least 0.5 and up to 1 and a molecular weight distribution, Mw/Mn, greater than 1.3; and/or
(G) average block index greater than zero and up to 1.0 and a molecular weight distribution, Mw/Mn greater than 1.3.

It is understood that the ethylene/α-olefin multi-block copolymer may have one, some, all, or any combination of properties (A)-(G). Block Index can be determined as described in detail in U.S. Pat. No. 7,608,668 herein incorporated by reference for that purpose. Analytical methods for determining properties (A) through (G) are disclosed in, for example, U.S. Pat. No. 7,608,668, col. 31 line 26 through col. 35 line 44, which is herein incorporated by reference for that purpose.

In an embodiment, the ethylene/α-olefin multi-block copolymer has hard segments and soft segments, is styrene-free, consists of only (i) ethylene and (ii) a C₄-C₈ α-olefin or C₈ α-olefin (and optional additives), and is defined as having a Mw/Mn from 1.7 to 3.5, at least one melting point, Tm, in degrees Celsius, and a density, d, in grams/cubic centimeter, wherein the numerical values of Tm and d correspond to the relationship:

$$Tm > - 200 \; 2.9 + 4 538.5 ( d ) - 2422.2 {( d )}^{2} ,$$

where the density, d, is from 0.850 g/cc, or 0.860 g/cc, or 0.870 g/cc to 0.875 g/cc, or 0.877 g/cc, or 0.880 g/cc, or 0.890 g/cc; and the melting point, Tm, is from 110° C., or 115° C., or 120° C. to 125° C., or 130° C., or 135° C.

In an embodiment, the ethylene/α-olefin multi-block copolymer is an ethylene/1-octene multi-block copolymer (consisting only of ethylene and octene comonomer) and has one, some, or all of the following properties:
(i) a Mw/Mn from 1.7, or 1.8 to 2.2, or 2.5, or 3.5; and/or
(ii) a density from 0.860 g/cc, or 0.865 g/cc, to 0.870 g/cc, or 0.877 g/cc, or 0.880 g/cc; and/or
(iii) a melting point, Tm, from 115° C., or 118° C., or 119° C., or 120° C. to 120° C., or 123° C., or 125° C.; and/or
(iv) a melt index (MI) from 0.1 g/10 min, or 0.5 g/10 min to 1.0 g/10 min, or 2.0 g/10 min, or 5 g/10 min, or 10 g/10 min; and/or
(v) from 50 to 85 wt % soft segment and from 40 to 15 wt % hard segment (based on total weight of the ethylene/octene multi-block copolymer); and/or
(vi) from 10 mol %, or 13 mol %, or 14 mol %, or 15 mol % to 16 mol %, or 17 mol %, or 18 mol %, or 19 mol %, or 20 mol % octene in the soft segment; and/or
(vii) from 0.5 mol %, or 1.0 mol %, or 2.0 mol %, or 3.0 mol % to 4.0 mol %, or 5 mol %, or 6 mol %, or 7 mol %, or 9 mol % octene in the hard segment; and/or
(viii) an elastic recovery (Re) from 50%, or 60% to 70%, or 80%, or 90%, at 300% min⁻¹ deformation rate at 21° C. as measured in accordance with ASTM D 1708; and/or
(ix) a polydisperse distribution of blocks and a polydisperse distribution of block sizes (hereafter referred to as multi-block copolymer properties (i)-(ix)).

In an embodiment, the ethylene/α-olefin multi-block copolymer is an ethylene/octene multi-block copolymer. The ethylene/octene multi-block copolymer is sold under the tradename INFUSE™, available from The Dow Chemical Company, Midland, Michigan, USA.

The ethylene/α-olefin multi-block copolymer can be produced via a chain shuttling process such as described in U.S. Pat. No. 7,858,706, which is herein incorporated by reference. In particular, suitable chain shuttling agents and related information are listed in col. 16 line 39 through col. 19 line 44. Suitable catalysts are described in col. 19 line 45 through col. 46 line 19 and suitable co-catalysts in col. 46 line 20 through col. 51 line 28. The process is described throughout the document, but particularly in col. 51 line 29 through col. 54 line 56. The process is also described, for example, in the following: U.S. Pat. Nos. 7,608,668; 7,893,166; and 7,947,793.

The ethylene/α-olefin multi-block copolymer may include more than one ethylene/α-olefin multi-block copolymer.

### B. Polar Ethylene-Based Polymer

The foam article (and/or the crosslinkable polymer composition) includes an ethylene-based polymer and/or a polar ethylene-based polymer. A “polar ethylene-based polymer,” as used herein, is an ethylene-based polymer composed of (i) ethylene monomer, (ii) a comonomer that contains a heteroatom, and (iii) an optional termonomer (that may or may not contain a heteroatom). Stated differently, the polar ethylene-based polymer is not a hydrocarbon. The polar ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of comonomers with a heteroatom include carbon monoxide, carboxylic acids, esters, alkyl acrylates having 1 to 30 carbon atoms, methacrylate esters having 1 to 30 carbon atoms, vinyl siloxanes having 1 to 16 carbon atoms and halogens. Nonlimiting examples of suitable polar ethylene-based polymer include ethylene/carboxylic acid copolymer and metal-salt partially neutralized ionomers derived thereof, ethylene/acrylic acid copolymer (EAA), ethylene/methacrylic acid copolymer (EMAA), ethylene/vinyl(trimethoxy)silane copolymer (EVTMS), ethylene/vinyl acetate copolymer (EVA), ethylene/methyl acrylate (EMA), ethylene/ethyl acrylate copolymer (EEA), ethylene/butyl acrylate copolymer (EBA), ethylene/carbon monoxide (ECO), ethylene/glycidyl methacrylate (E/GMA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinyldichloride (PVCD), ethylene/maleic anhydride copolymer (EMAH), polyvinylchloride (PVC), and combinations thereof. Additional nonlimiting terpolymer examples include ethylene/carboxylic acid/acrylate terpolymers and metal-salt partially neutralized ionomers derived thereof, ethylene/methyl acrylate/vinyl(trimethoxy)silane terpolymer copolymer (EMAVTMS), ethylene/ethyl acrylate/vinyl(trimethoxy)silane terpolymer copolymer (EEAVTMS), ethylene/butyl acrylate/vinyl(trimethoxy)silane terpolymer copolymer (EBAVTMS), ethylene/methyl acrylate/glycidyl methacrylate (EMAGMA) ethylene/butyl acrylate/glycidyl methacrylate (EBAGMA), ethylene/vinyl acetate/maleic anhydride terpolymer (EEAMAH), ethylene ethyl acrylate/maleic anhydride (EEAMAH) terpolymer, and combinations thereof.

In an embodiment, the polar ethylene-based polymer is an ethylene/vinyl acetate copolymer.

### D. Free Radical Initiator

The foam article is formed from a crosslinkable composition composed of the ethylene-based polymer and/or the polar ethylene-based polymer, a free radical initiator, the BiTEMPS methacrylate, and optional additives. The crosslinkable composition includes a free radical initiator.

The amount of the free radical initiator in the crosslinkable polymer composition or foam article can be from about greater than 0 to about 10 wt %, from about 0.1 to about 7.5 wt %, or from about 1 to about 5 wt % based on the weight of the ethylene-based polymer and/or polar ethylene-based polymer or the polymer blend.

Non-limiting examples of suitable free radical initiators include peroxides, phenols, azides, aldehyde-amine reaction products, Substituted ureas, Substituted guanidines; substituted xanthates; substituted dithiocarbamates; sulfur containing compounds, such as thiazoles, sulfenamides, thiuramidisulfides, paraquinonedioxime, dibenzoparaquino nedioxime, sulfur, imidazoles; silanes and combinations thereof.

In an embodiment, the free radical initiator is an organic peroxide. In certain embodiments, the organic peroxide is a molecule containing carbon atoms, hydrogen atoms, and two or more oxygen atoms, and having at least one —O—O— group, with the proviso that when there are more than one —O—O— group, each —O—O— group is bonded indirectly to another —O—O— group via one or more carbon atoms, or collection of such molecules.

The organic peroxide may be a dialkyl peroxide. It may be a monoperoxide of formula RO—O—O—RO, wherein each RO independently is a (C₁-C₂₀)alkyl group or (C₆-C₂₀)aryl group. Each (C₁-C₂₀)alkyl group independently is unsubstituted or substituted with 1 or 2 (C₆-C₁₂)aryl groups. Each (C₆-C₂₀)aryl group is unsubstituted or substituted with 1 to 4 (C₁-C₁₀)alkyl groups. Alternatively, the organic peroxide may be a diperoxide of formula RO—O—O—R—O—O—RO, wherein R is a divalent hydrocarbon group such as a (C₂-C₁₀)alkylene, (C₃-C₁₀)cycloalkylene, or phenylene, and each RO is as defined above.

The peroxide may be a peroxycarbonate. Suitable peroxycarbonate type peroxides include isopropyl percarbonate; t-butylperoxy-2-ethylhexyl-carbonate, tert-amylperoxy-2-ethylhexyl carbonate, tert-butylperoxy isopropyl carbonate, tert-butyl peroxy-3,5,5-trimethylhexanoate. The peroxide may be a diacylperoxide. Non-limiting examples of suitable acylperoxide type peroxide includes dilauroyl peroxide; benzoyl peroxide; didecanoyl peroxide;

The peroxide may be a peroxyester. Non-limiting examples of suitable peroxyester type peroxide includes tert-butyl peroxybenzoate, tert-butyl peroxyacetate, tert-amyl peroxybenzoate, tert-butyl peroxy-3,5,5-trimethylhexanoate; tert-butyl peroxyisobutyrate; tert-butyl peroxydiethylacetate; tert-butyl peroxy-2-ethylhexanoate; tert-amyl peroxy-2-ethylhexanoate; 1,1,3,3-tetramethylbutyl peroxy-2-ethylhexanoate; 2,5-Dimethyl-2,5-di(2-ethylhexanoylperoxy)hexane. The peroxide may be a peroxyketals. Non-limiting examples of suitable peroxyketals type peroxide includes 1,1-bis(tbutylperoxy)-3,3,5-trimethylcyclohexane; 1,1-di(tert-butylperoxy)cyclohexane; 1,1-di(tert-amylperoxy)cyclohexane.

The peroxide may be a cyclic ketone peroxide. Non-limiting examples of suitable cyclic ketone peroxide includes 3,6,9-triethyl-3,6,9-trimethyl-1,4,7-triperoxonane.

Nonlimiting examples of suitable organic peroxide include bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1 dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(α-t-butyl-peroxyisopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; di(isopropylcumyl) peroxide; dicumyl peroxide, and combinations thereof. Non-limiting examples of suitable commercially available organic peroxides include TRIGONOX© from AkzoNobel and LUPEROX® from ARKEMA.

In an embodiment the free radical initiator is dicumyl peroxide and/or bis(α-t-butyl-peroxyisopropyl) benzene. In some embodiments the foam or crosslinkable compositions disclosed herein can comprise a crosslinking coagent. As used herein, a “crosslinking coagent” is a compound that promotes crosslinking; for example, by helping to establish a higher concentration of reactive sites and/or helping to reduce the chance of deleterious radical side reactions. Crosslinking coagents include, but are not limited to, triallyl cyanurate (TAC), triallyl phosphate (TAP), triallyl isocyanurate (TAIC), 1,3,5,7-tetravinyl-1,3,5,7-tetramethylcyclotetrasiloxane (Vinyl D4), 2,4,6-trimethyl-2,4,6-trivinyl-1,3,5,2,4,6-trioxatrisilinane (Vinyl D3), 2,4,6,8,10-pentamethyl-2,4,6,8,10-pentavinyl-1,3,5,7,9,2,4,6,8,10-pentaoxapentasilecane (Vinyl D5), dipentaerythritolpenta-acrylate and trimethylolpropane triacrylate, triallyl trimellitate; N,N,N′,N′,N″,N″-hexaallyl-1,3,5-triazine-2,4,6-triamine; triallyl orthoformate; pentaerythritol triallyl ether; triallyl citrate; triallyl aconitate; trimethylolpropane triacrylate; trimethylolpropane trimethylacrylate; ethoxylated bisphenol A dimethacrylate; 1,6-hexanediol diacrylate; pentaerythritol tetraacrylate; dipentaerythritol pentaacrylate; tris(2-hydroxyethyl) isocyanurate triacrylate; propoxylated glyceryl triacrylate; a polybutadiene having at least 50 wt % 1,2-vinyl content; trivinyl cyclohexane; and mixtures of any two or more thereof.

Alternatively, the crosslinking of the foam or the crosslinkable polymer composition disclosed herein can be effected by using radiation. Non-limiting examples of suitable radiation include electron beam or beta ray, gamma rays, X-rays, or neutron rays. Radiation is believed to activate the cross linking by generating radicals in the polymer which may Subsequently combine and cross-link. In some embodiments, the foam or crosslinkable composition is not crosslinked by radiation.

Radiation dosage generally depends upon many factors. Suitable radiation levels based on thickness and geometry of the article to be irradiated, as well as the characteristics of the ethylene-based polymer and/or polar ethylene-based polymer or the polymer blend, such as molecular weight, molecular weight distribution, comonomer content, the presence of cross-linking enhancing coagents, additives (e.g., oil), and the like. In general, the dosage does not exceed what is required to effect the desired level of crosslinking. In some embodiments, the dosage causes more than 5% gel in the foam per ASTM D-2765-84 Method A.

In some embodiments, dual cure systems, which comprises at least two activation methods selected from free radical initiators and radiation, can be effectively employed. For instance, it may be desirable to employ a peroxide free radical initiator in conjunction with a silane free radical initiator, a peroxide free radical initiator in conjunction with radiation, a sulfur-containing free radical initiator in conjunction with a silane free radical initiator, or the like.

It is contemplated that the ethylene-based polymer and/or polar ethylene-based polymer can be blended with other polymers and polyolefins prior to crosslinking.

### E. BiTEMPS Methacrylate

The foam article and/or the crosslinkable polymer composition includes 2,2,6,6-tetramethyl-4-piperidyl methacrylate disulfide, interchangeably referred to as “BiTEMPS methacrylate,” or “BiTEMPS” or “BiT.” BiTEMPS methacrylate disulfide has the Structure 1 below.

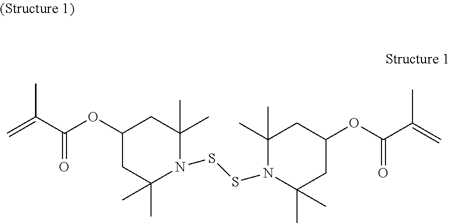 [SMILES: C=C(C)C(=O)OC1CC(C)(C)N(SSN2C(C)(C)CC(OC(=O)C(=C)C)CC2(C)C)C(C)(C)C1]

In an embodiment, the crosslinkable polymer composition includes
from 70 wt % to 98.5 wt %, or from 77 wt % to 98.5 wt % of the ethylene-based polymer and/or polar ethylene-based polymer;
from 0.5 wt % to 10 wt %, or from 0.5 wt % to 5 wt % 0.5 wt % to 3.0 wt % or from 0.5 wt % to 1.5 wt %, or from 1.5 wt % to 3.0 wt % free radical initiator that is an organic peroxide (such as dicumyl peroxide for example); and
from 1 wt % to 20 wt %, or from 1 wt % to 15 wt %, or from 3 wt % to 20 wt %, or from 3 wt % to 10 wt % BiTEMPS methacrylate disulfide. It is understood that the aggregate of the ethylene-based polymer (and/or polar ethylene-based polymer), the free radical initiator, and the BiTEMPS methacrylate disulfide (and optional additives) amount to 100 wt % of the crosslinkable polymer composition.

The present disclosure provides a crosslinked composition. The crosslinkable polymer composition is melt blended at a temperature from 70° C. to 250° C., or from 80° C. to 200° C. or from 90° C. to 180° C., or from 100° C. to 160° C., or from 130° C. to 250° C., or from 140° C. to 200° C., or from 150° C. to 180° C., or from 160° C. to 175° C. to trigger the crosslinking reaction and form the crosslinked composition. In an embodiment, the crosslinked composition includes an ethylene-based polymer and/or a polar ethylene-based polymer and 2,2,6,6-tetramethyl-4-piperidyl methacrylate disulfide (BiTEMPS methacrylate). The crosslinked composition contains disulfide linkages formed from the BiTEMPS methacrylate by way of the crosslinking reaction, the disulfide linkages having the Structure 2 below.

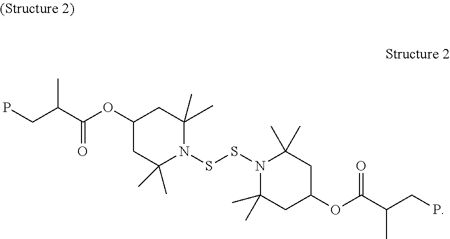

The term (and structure) “P” in Structure 2 above refers to the chain of polymerized ethylene (and optional comonomer(s)) for the ethylene-based polymer. The ethylene-based polymer (and/or polar ethylene-based polymer) of the crosslinked composition can be any ethylene-based polymer (and/or polar ethylene-based polymer) with a MI from 0.1 g/10 min to 100 g/10 min as previously disclosed herein. Nonlimiting examples of suitable ethylene-based polymer (and/or polar ethylene-based polymer) include ethylene plastomer/elastomer, high density polyethylene (HDPE), linear low density polyethylene (LLDPE), low density polyethylene (LDPE), ethylene/α-olefin multi-block copolymer, ethylene vinyl acetate, and combinations thereof.

In an embodiment, the ethylene-based polymer and/or polar ethylene-based polymer (interchangeably referred to as “(polar) ethylene-based polymer”) is a virgin (polar) ethylene-based polymer. A “virgin (polar) ethylene-based polymer,” as used herein, is a (polar) ethylene-based polymer that has not been subjected to a crosslinking reaction. In other words, the term “virgin (polar) ethylene-based polymer” refers to the (polar) ethylene-based polymer that is present in the crosslinked composition prior to the (polar) ethylene-based polymer being crosslinked with the BiTEMPS methacrylate. The virgin (polar) ethylene-based polymer is the (polar) ethylene-based polymer prior to crosslinking, the crosslinked composition containing the same (polar) ethylene-based polymer that was virgin but is now crosslinked with BiTEMPS methacrylate. In this way, the virgin (polar) ethylene-based polymer serves as a baseline to evaluate the properties of the crosslinked composition. The crosslinked composition has
(i) a storage modulus value, G′, at 140° C. that is greater than the storage modulus value, G′, for the virgin ethylene-based polymer at 140° C.;
(ii) a tan delta value at 60° C. that is less than the tan delta value of the virgin ethylene-based polymer at 60° C.; and
(iii) a tan delta value at 140° C. that is less than the tan delta value of the virgin ethylene-based polymer at 140° C.

In an embodiment, the crosslinked composition includes from 80 wt % to 97 wt % of the ethylene-based polymer and from 3 wt % to 20 wt % BiTEMPS methacrylate, the aggregate of the ethylene-based polymer and the BiTEMPS methacrylate (and optional additives) amounting to 100 wt % of the crosslinked composition.

### F. Blend Component

In an embodiment, the crosslinkable composition and/or the crosslinked composition includes a blend component. Nonlimiting examples of suitable blend component include polyolefins (e.g., polyethylene other than the ethylene-based polymer crosslinked with BiTEMPS methacrylate and polypropylene), polymers (e.g., polystyrene, ABS, SBS and the like) and combinations thereof. Non-limiting examples of suitable polyolefins include polyethylene; polypropylene; polybutylene (e.g., polybutene-1); polypentene-1; polyhexene-1; polyoctene-1; polydecene-1; poly-3-methylbutene-1; poly-4-methylpentene-1; polyisoprene; polybutadiene; poly-1,5-hexadiene; interpolymers derived from olefins; interpolymers derived from olefins and other polymers such as polyvinyl chloride, polystyrene, polyurethane, and the like; and mixtures thereof.

In an embodiment, the polyolefin is a homopolymer such as polyethylene, polypropylene, polybutylene, polypentene-1, poly-3-methylbutene-1, poly-4-methylpentene-1, polyisoprene, polybutadiene, poly-1,5-hexadiene, polyhexene-1, polyoctene-1 and polydecene-1.

Nonlimiting examples of suitable polyethylene as blend component (other than the ethylene-based polymer that is crosslinked with BITEMPS methacrylate) include ultra low density polyethylene (ULDPE), linear low density polyethylene (LLDPE), low density polyethylene (LDPE), medium density polyethylene (MDPE), high density polyethylene (HDPE), high molecular weight high density polyethylene (HMW-HDPE), ultra high molecular weight polyethylene (UHMW-PE) and combinations thereof. Nonlimiting examples of polypropylene include low density polypropylene (LDPP), high density polypropylene (HDPP), high-melt strength polypropylene (HMS-PP) and combination thereof. In an embodiment, the blend component is a high-melt-strength polypropylene (HMS-PP), a low density polyethylene (LDPE) or a combination thereof.

### G. Additives

The crosslinkable composition and/or the crosslinked composition may contain one or more optional additives. Nonlimiting examples of suitable additives include grafting initiators, cross-linking catalysts, blowing agent, blowing agent activators (e.g., zinc oxide, zinc stearate and the like), coagents (e.g., triallyl cyanurate), plasticizers, processing oils, processing aids, carbon black, colorants or pigments, stability control agents, nucleating agents, fillers, antioxidants, acid scavengers, ultraviolet (UV) stabilizers, flame retardants, lubricants, processing aids, extrusion aids, and combinations thereof. When present, the total amount of additive can be from greater than 0 to 80%, or from 0.001% to 70%, or from 0.01% to 60%, or from 0.1% to 50%, or from 0.1% to 40%, or from 0.1% to 20%, or from 0.1% to 10%, or from 0.1% to 5% of the total weight of the composition.

In an embodiment, the crosslinkable composition and/or the crosslinked composition includes an antioxidant. Non-limiting examples of suitable antioxidants include aromatic or hindered amines such as alkyl diphenylamines, phenyl-a-naphthylamine, alkyl or aralkyl substituted phenyl-a-naphthylamine, alkylated p-phenylene diamines, tetramethyl-diaminodiphenylamine and the like; phenols such as 2,6-di-t-butyl-4-methylphenol; 1,3,5-trimethyl-2,4,6-tris(3′,5,-di-t-butyl-4,-hydroxybenzyl)benzene; tetrakis[(methylene(3,5-di-t-butyl-4-hydroxyhydrocinnamate)]methane (e.g., IRGANOX™ 1010, from Ciba Geigy, NewYork); acryloyl modified phenols; octadecyl-3,5-di-t-butyl-4-hydroxycinnamate (e.g., IRGANOX™ 1076, commercially available from Ciba Geigy); phosphites and phosphonites; hydroxylamines; benzofuranone derivatives; and combinations thereof. Where used, the amount of the antioxidant in the composition can be from greater than 0 to 5 wt %, or from 0.0001 to 2.5 wt %, or from 0.001 to 1 wt %, or from 0.001 to 0.5 wt % of the total weight of the composition.

In an embodiment, the crosslinkable composition and/or the crosslinked composition includes a UV stabilizer. Non-limiting examples of suitable UV stabilizers include benzophenones, benzotriazoles, aryl esters, oxanilides, acrylic esters, formamidines, carbon black, hindered amines, nickel quenchers, hindered amines, phenolic antioxidants, metallic salts, zinc compounds and combinations thereof. Where used, the amount of the UV stabilizer can be from greater than 0 to 5 wt %, or from 0.01 wt % to 3 wt %, or from 0.1 wt % to 2 wt %, or from 0.1 wt % to 1 wt % of the total weight of the composition.

In an embodiment, the crosslinkable composition and/or the crosslinked composition includes a colorant or a pigment. Non-limiting examples of suitable colorants or pigments include inorganic pigments such as metal oxides such as iron oxide, zinc oxide, and titanium dioxide, mixed metal oxides, carbon black, organic pigments such as anthraquinones, anthanthrones, azo and monoazo compounds, arylamides, benzimidazolones, BONA lakes, diketopyrrolo-pyrroles, dioxazines, disazo compounds, diarylide compounds, flavanthrones, indanthrones, isoindolinones, isoindolines, metal complexes, monoazo salts, naphthols, b-naphthols, naphthol AS, naphthol lakes, perylenes, perinones, phthalocyanines, pyranthrones, quinacridones, andquinophthalones, and combinations thereof. Where used, the amount of the colorant or pigment in the composition can be from greater than 0 to 10 wt %, or from 0.1 wt % to 5 wt %, or from 0.25 wt % to 2 wt % of the total weight of the composition.

In an embodiment, the crosslinkable composition and/or the crosslinked composition includes a filler. Nonlimiting examples of suitable fillers include talc, calcium carbonate, chalk, calcium sulfate, clay, kaolin, silica, glass, fumed silica, mica, wollastonite, feldspar, aluminum silicate, calcium silicate, alumina, hydrated alumina such as alumina trihydrate, glass microsphere, ceramic microsphere, thermoplastic microsphere, barite, wood flour, glass fibers, carbon fibers, marble dust, cement dust, magnesium oxide, magnesium hydroxide, antimony oxide, zinc oxide, barium sulfate, titaniumdioxide, titanates and combinations thereof.

In an embodiment, the filler is barium sulfate, talc, calcium carbonate, silica, glass, glass fiber, alumina, titanium dioxide, or a mixture thereof. In a further embodiment, the filler is talc, calcium carbonate, barium sulfate, glass fiber or a mixture thereof. Where used, the amount of the filler in the composition can be from greater than 0 to 80 wt %, or from 0.1 to 60 wt %, or from 0.5 to 40 wt %, or from 1 to 30 wt %, or from 10 to 40 wt % of the total weight of the composition.

In an embodiment, the crosslinkable composition and/or the crosslinked composition includes a lubricant. Nonlimiting examples of suitable lubricants include fatty alcohols and their dicarboxylic acid esters, fatty acid esters of short chain alcohols, fatty acids, fatty acid amides, metal soaps, oligomeric fatty acid esters, fatty acid esters of long-chain alcohols, montan waxes, polyethylene waxes, polypropylene waxes, natural and synthetic paraffin waxes, fluoropolymers and combinations thereof. Where used, the amount of the lubricant in the composition can be from greater than 0 wt % to 5 wt %, or from 0.1 to 4 wt %, or from 0.1 wt % to 3 wt % of the total weight of the composition.

In an embodiment, the crosslinkable composition and/or the crosslinked composition includes an antistatic agent. Non-limiting examples of suitable antistatic agents include conductive fillers (e.g., carbon black, metal particles and other conductive particles), fatty acid esters (e.g., glycerol monostearate), ethoxylated alkylamines, diethanolamides, ethoxylated alcohols, alkylsulfonates, alkylphosphates, quaternary ammonium salts, alkylbetaines and combinations thereof. Where used, the amount of the antistatic agent in the composition can be from greater than 0 wt % to 5 wt %, or from 0.01 to 3 wt %, or from 0.1 to 2 wt % of the total weight of the composition.

### H. Foam Article

In an embodiment, the crosslinkable polymer composition and/or the crosslinked composition includes a blowing agent. The blowing agent is used for foaming the crosslinked composition. The blowing agents suitable for making the foams disclosed herein can include, but are not limited to, inorganic blowing agents, organic blowing agents, chemical blowing agents and combinations thereof.

The amount of the blowing agent in the crosslinkable polymer composition disclosed herein may be from about 0.1 to about 20 wt %, from about 0.1 to about 10 wt %, or from about 0.1 to about 5 wt %, based on the weight of the ethylene-based polymer and/or polar ethylene-based polymer or the polymer blend. In other embodiments, the amount of the blowing agent is from about 0.2 to about 5.0 moles per kilogram of the interpolymer or polymer blend, from about 0.5 to about 3.0 moles per kilogram of the interpolymer or polymer blend, or from about 1.0 to about 2.50 moles per kilogram of the interpolymer or polymer blend.

Nonlimiting examples of suitable blowing agent include an inorganic physical blowing agent, such as air, argon, nitrogen, carbon dioxide, helium, oxygen, and neon, and an organic physical blowing agent, such as an aliphatic hydrocarbon, e.g., propane, n-butane, isobutane, n-pentane, isopentane, and n-hexane, an alicyclic hydrocarbon, e.g., cyclohexane and cyclopentane, a halogenated hydrocarbon, e.g., chlorofluoromethane, trifluoromethane, 1,1-difluoroethane, 1,1,1,2-tetrafluoroethane, methyl chloride, ethyl chloride, and methylene chloride, and a dialkyl ether, e.g., dimethyl ether, diethyl ether, and methyl ethyl ether.

Non-limiting examples of suitable organic blowing agents include aliphatic hydrocarbons having 1-6 carbon atoms, aliphatic alcohols having 1-3 carbon atoms, and fully and partially halogenated aliphatic hydrocarbons having 1-4 carbon atoms. Non-limiting examples of suitable aliphatic hydrocarbons include methane, ethane, propane, n-butane, isobutane, n-pentane, isopentane, neopentane, and the like. Non-limiting examples of suitable aliphatic alcohols include methanol, ethanol, n-propanol, and isopropanol. Non-limiting examples of suitable fully and partially halogenated aliphatic hydrocarbons include fluorocarbons, chlorocarbons, and chlorofluorocarbons. Non-limiting examples of suitable fluorocarbons include methyl fluoride, perfluoromethane, ethyl fluoride, 1,1-difluoroethane (HFC152a), 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Non-limiting examples of suitable partially halogenated chlorocarbons and chlorofluorocarbons include methyl chloride, methylene chloride, ethyl chloride, 1,1,1-trichloroethane, 1,1-dichloro-1-fluoroethane (HCFC-141b), I-chloro-I,Idifluoroethane (HCFC-142b), I,I-dichloro-2,2,2-trifluoroethane (HCFC-123) and I-chloro-I,2,2,2-tetrafluoroethane(HCFC-124). Non-limiting examples of suitable fully halogenated chlorofluorocarbons include trichloromonofluoromethane (OPOI 1), dichlorodifluoromethane (CFO-12), trichlorotrifluoroethane (CFO-113), 1,1,1-trifluoroethane, pentafluoroethane, dichlorotetrafluoroethane (CFO-114), chloroheptafluoropropane, and dichlorohexafluoropropane.

Non-limiting examples of suitable chemical blowing agents include azodicarbonamide, azodiisobutyro-nitrile, benezenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, and trihydrazino triazine.

The ingredients of the foams, i.e., the polymer component, BITEMPS methacrylate, the blowing agent, and the free radical initiator and optional additives can be mixed or blended. Non-limiting examples of suitable blending methods include melt blending, solvent blending, extruding, and the like.

In some embodiments, the ingredients of the foams are melt blended by a method as described by Guerin et al. in U.S. Pat. No. 4,152,189. First, all solvents, if there are any, are removed from the ingredients by heating to an appropriate elevated temperature of about 100° C. to about 200° C. or about 150° C. to about 175° C. at a pressure of about 5 torr (667 Pa) to about 10 torr (1333 Pa). Next, the ingredients are weighed into a vessel in the desired proportions and the foam is formed by heating the contents of the vessel to a molten state while stirring.

In other embodiments, the ingredients of the foams are processed using solvent blending. First, the ingredients of the desired foam are dissolved in a suitable solvent and the mixture is then mixed or blended. Next, the solvent is removed to provide the foam.

In further embodiments, physical blending devices that can provide dispersive mixing, distributive mixing, or a combination of dispersive and distributive mixing can be used in preparing homogenous blends. Both batch and continuous methods of physical blending can be used. In some embodiments the ethylene-based polymer and/or the polar ethylene-based polar, peroxide, BiTEMPS and optional additive (antioxidant, pigment, adhesion promoter, filler, nucleating agent, rubber, stabilizer, processing aid, activator for the blowing agent such as metal oxide), and blowing agent may be melt blended by way of Banbury mixer, intensive mixer, two-roll mill, and extruder, and combinations thereof. Time, temperature, and shear rate can be regulated to ensure dispersion without premature crosslinking or foaming. After the crosslinkable polymer composition has been mixed, the crosslinkable polymer composition is formed into a desired shape. Sheeting rolls or calendar rolls can be used to make appropriately dimensioned sheets for foaming. An extruder may be used to shape the crosslinkable polymer composition into pellets.

Foaming is accomplished by way of compression molding, injection molding, and hybrids of extrusion and molding of the crosslinkable composition. Foaming may be performed by placing the crosslinkable composition into a compression mold (or into an autoclave) at a pressure, temperature and time sufficient to complete the decomposition of the peroxide and/or the blowing agent. The crosslinkable polymer composition is impregnated with blowing agent (physical blowing agent and/or chemical blowing agent) either prior to entry into the compression mold/autoclave, or once the crosslinkable polymer composition is placed into the compression mold/autoclave. Pressure and heat are applied to the compression mold/autoclave. Rapid depressurization and release of the compression mold/autoclave triggers foam formation. The resultant foam can be further shaped as desired by way of thermoforming and/or compression molding.

When a free radical initiator is used, the crosslinking of the foam article can be induced by activating the free radical initiator in the crosslinkable composition. The free radical initiator can be activated by exposing it to a temperature above its decomposition temperature. Alternatively, the free radical initiator can be activated by exposing it to a radiation that causes the generation of free radicals from the free radical initiator. Similarly, the foaming or expansion of the foam article disclosed herein can be induced by activating the blowing agent in the crosslinkable composition. In some embodiments, the blowing agent is activated by exposing it to a temperature above its activation temperature. Generally, the activations of the crosslinking and foaming can occur either simultaneously or sequentially. In some embodiments, the activations occur simultaneously. In other embodiments, the activation of the crosslinking occurs first and the activation of the foaming occurs next. In further embodiments, the activation of the foaming occurs first and the activation of the crosslinking occurs next.

The crosslinkable polymer composition can be prepared or processed at a temperature of less than 150° C. to prevent the decomposition of the blowing agent and the free radical initiator. When radiation crosslinking is used, the crosslinkable polymer composition can be prepared or processed at a temperature of less than 160° C. to prevent the decomposition of the blowing agent. In some embodiments, the crosslinkable polymer composition can be extruded or processed through a die of desired shape to form a crosslinkable structure. Next, the crosslinkable structure can be expanded and crosslinked at an elevated temperature (e.g., from about 150° C. to about 250° C.) to activate the blowing agent and the free radical initiator to form a foam structure. In some embodiments, the foam able structure can be irradiated to crosslink the polymer material, which can then be expanded at the elevated temperature as described above.

The foam articles disclosed herein can be prepared by conventional extrusion foaming processes. The foam article can generally be prepared by heating the ethylene-based polymer and/or polar ethylene-based polymer or the polymer blend to form a plasticized or melt polymer material, incorporating therein a blowing agent to form a crosslinkable composition, and extruding the crosslinkable composition through a die to form foam products. Prior to mixing with the blowing agent, the ethylene-based polymer and/or polar ethylene-based polymer can be heated to a temperature at or above its glass transition temperature or melting point. The blowing agent can be incorporated or mixed into the molten ethylene-based polymer and/or polar ethylene-based polymer such as with an extruder, mixer, blender, and the like. The blowing agent can be mixed with the molten ethylene-based polymer and/or polar ethylene-based polymer at an elevated pressure sufficient to prevent Substantial expansion of the molten ethylene-based polymer and/or polar ethylene-based polymer and to generally disperse the blowing agent homogeneously therein. Optionally, a nucleating agent can be blended in the interpolymer melt or dry blended with the ethylene-based polymer and/or polar ethylene-based polymer prior to plasticizing or melting. The crosslinkable polymer composition can be cooled to a lower temperature to optimize physical characteristics of the foam structure. The crosslinkable polymer composition can be then extruded or conveyed through a die of desired shape to a zone of reduced or lower pressure to form the foam structure. The zone of lower pressure can be at a pressure lower than that in which the crosslinkable polymer composition is maintained prior to extrusion through the die. The lower pressure can be super-atmospheric or sub-atmospheric (vacuum), but is preferably at an atmospheric level.

The foams or crosslinkable compositions disclosed herein can have a density from 150 to about 600 kg/m, from 150 to about 500 kg/m, from 150 to about 400 kg/m, from 150 to about 350 kg/m, from about 150 to about 300 kg/m, or from about 150 to about 250 kg/m. In some embodiments, the foam disclosed herein has a density from 150 to about 500 kg/m. In other embodiments, the foam disclosed herein has a density from 175 to about 500 kg/m. In further embodiments, the foam disclosed herein has a density from 200 to about 500 kg/m.

The foaming process forms the foam article. The foam article is composed of the crosslinked foam composition. The crosslinked foam composition includes the ethylene-based polymer and/or the polar ethylene-based polymer, the BiTEMPS, and optional additive(s). In some embodiments, the foam article disclosed herein can have an average cell size from 0.05 to 5.0 g/cc, from 0.2 to 2.0 g/cc, from 0.1 to 1.5 g/cc, from 0.1 to 1.0 g/cc, or from 0.2 to 0.6 g/cc according to ASTM D3576. In some embodiments the crosslinked foam composition has uniform closed foam cells and has a density less than 0.2 g/cc, or from 0.05 g/cc to 0.2 g/cc, or from 0.05 g/cc to 0.15 g/cc.

In embodiment, the foam article is a crosslinked foam composition composed of an ethylene-based polymer, linkages of Structure 2 (formed from the BiTEMPS), and optional additive. The ethylene-based polymer is an ethylene/octene multi-block copolymer. The crosslinked foam composition has uniform closed foam cells. The crosslinked foam composition comprises, consists essentially or, or consists of:
(i) from 50 wt % to 99 wt % of the ethylene/octene multi-block copolymer having
(a) a density from 0.850 g/cc to 0.905 g/cc, and
(b) an MI from 0.2 g/10 min to 100 g/10 min,
(ii) linkages of Structure 2 (formed from 1 wt % to 15 wt % of the BiTEMPS methacrylate);
(iii) 0 wt %, or from 0.1 wt % to 1.0 wt % of additives, the aggregate of the ethylene-based polymer and linkages of Structure 2 (formed from the BiTEMPS methacrylate) (and optional additives) amounting to 100 wt % of the crosslinked foam composition and the crosslinked foam composition has one, some, or all of the following properties:
(iv) a density from 0.05 g/cc to 0.3 g/cc; and/or 0.08 g/cc to 0.25 g/cc; and/or 0.1 g/cc to 0.2 g/cc
(v) a tensile strength from 0.7 MPa to 4 MPa; and/or 1 MPa to 3 MPa; and/or 1.5 MPa to 2.8 MPa
(vi) a rebound from 40% to 90%; and/or 50% to 80%; and/or 55% to 75%
(vii) a hardness (Asker C) from 5 to 60.

In an embodiment, the foam article is a crosslinked foam composition composed of a polar ethylene-based polymer, linkages of Structure 2 (formed from the BiTEMPS), and optional additive. The crosslinked foam composition has uniform closed foam cells and has a density less than 0.2 g/cc, or from 0.05 g/cc to 0.2 g/cc, or from 0.05 g/cc to 0.15 g/cc.

In embodiment, the foam article is a crosslinked foam composition composed of a polar ethylene-based polymer, linkages of Structure 2 (formed from the BiTEMPS), and optional additive. The polar ethylene-based polymer is ethylene vinyl acetate. The crosslinked foam composition has uniform closed foam cells. The crosslinked foam composition comprises, consists essentially or, or consists of:
(i) from 5 wt % to 100 wt % of the ethylene vinyl acetate, the ethylene vinyl acetate having
(a) a density from 0.921 g/cc to 0.965 g/cc,
(b) an MI from 0.3 g/10 min to 500 g/10 min,
(c) a vinyl acetate content from 1 wt % to 40 wt % (based on the total weight of the ethylene vinyl acetate);
(ii) linkages of Structure 2 (formed from 1 wt % to 15 wt % of the BiTEMPS methacrylate);
(iii) 0 wt %, or from 0.1 wt % to 1.0 wt % of additives, the aggregate of the ethylene-based polymer and the linkages of Structure 2 (formed from the BiTEMPS methacrylate) (and optional additives) amounting to 100 wt % of the crosslinked foam composition.

The foams disclosed herein may take any physical forms, such as sphere, cylinder, disk, cube, prism, sheet, plank, foam slab stock or irregular shapes. Further, they can be injection molded articles, compression molded articles, or extruded articles. Other useful forms are expandable or crosslinkable particles, moldable foam particles, or beads, and articles formed by expansion and/or coalescing and welding of those particles. Nonlimiting examples of suitable foam articles include footwear (e.g., midsoles of footwear), packaging, sporting goods, construction materials, and insulation.

In some footwear applications such as inner soles, midsoles, outer soles, unisoles, and sole inserts, the foams disclosed herein can be substantially cross-linked. A foam is substantially cross-linked when the foam contains more than 5% of gel per ASTM D-2765-84 Method A. In some embodiments, the foam disclosed herein contains more than about 5% of gel, more than about 10% of gel, more than about 15% of gel, more than about 20% of gel, more than about 25% of gel, more than about 30% of gel, more than about 35% of gel, or more than about 40% of gel per ASTM D-2765-84 Method A. In other embodiments, the foam disclosed herein contains less than about 95% of gel. In further embodiments, the foam disclosed herein contains less than about 85% of gel. In further embodiments, the foam disclosed herein contains less than about 75% of gel.

### I. Reprocessability

BiTEMPS methacrylate is a “dynamic crosslinker.” The dynamic crosslinker BiTEMPS methacrylate enables formation of a crosslinked network with the ethylene-based polymer by way of disulfide linkages between the chains of the ethylene-based polymer (in the presence of the free radical initiator) to form the crosslinked ethylene-based polymer composition. The crosslinking is dynamic because the disulfide linkages may be broken, allowing for chain mobility and exchange when the crosslinked ethylene-based polymer composition is subjected to a “reprocessing temperature,” the reprocessing temperature being a temperature from 130° C. to 300° C., or from 140° C. to 280° C., or from 150° C. to 270° C., or from 160° C. to 255° C. At the reprocessing temperature, the disulfide linkages in the crosslinked ethylene-based polymer composition are broken, forming a re-processable ethylene-based polymer composition. Cooling the re-processable ethylene-based composition below the reprocessing temperature forms a re-crosslinked ethylene-based polymer composition.

The dynamic crosslinker BiTEMPS methacrylate enables a cyclic “reprocessing” for fabrication of new polymeric articles. When the crosslinked ethylene-based polymer composition is heated to the reprocessing temperature, the disulfide linkages break, or otherwise cleave, enabling the previously-crosslinked ethylene-based polymer composition to flow at the reprocessing temperature, forming “a re-processable ethylene-based polymer composition.” Heating to the reprocessing temperature enables link breaking and polymer chain flow, allowing the ethylene-based composition to be reshaped readily. At the reprocessing temperature, the re-processable ethylene-based polymer composition is no longer crosslinked, but rather is flowable, enabling shaping and/or fabrication of the now flowable re-processable ethylene-based composition (with BiTEMPS methacrylate) into a new pre-form or article. Upon cooling to below the “reprocessing temperature,” the disulfide linkages form again, the network is re-established, and the re-crosslinked ethylene-based compositions is formed in the new article configuration with a return to the high viscosity (no flow at room temperature) and resistance to mechanical deformation indicative of the crosslinked network. When the newly-formed article of the re-processable ethylene-based polymer composition is cooled below the reprocessing temperature, the disulfide linkages in the re-processable ethylene-based polymer composition are re-established, and the ethylene-based polymer (with BiTEMPS methacrylate) becomes a re-crosslinked ethylene-based polymer composition in the shape of the newly-fabricated article. Below the reprocessing temperature, the network disulfide linkages are stable, and the re-crosslinked ethylene-based polymer composition exhibits the high viscosity and resistance to mechanical deformation indicative of a crosslinked network. This cycle of crosslink/re-process/re-crosslink and fabrication into a new article can be repeated.

Bounded by no particular theory, the number of “reprocessing” cycles that are possible with the present crosslinked ethylene-based composition (before competitive thermal and oxidative permanent crosslinking occurs and prevents further reprocessing), can be determined by calculating the ratio of the melt viscosity of the crosslinked ethylene-based polymer composition before and after a reprocessing cycle. For the crosslinked ethylene-based polymer composition to be re-processable, the ratio of the Mooney viscosity after reprocessing to the Mooney viscosity before reprocessing is from 0.5 to 5, or from 0.7 to 3 or from 0.9 to 2 or from 0.95 to 1.2.

Other metrics for monitoring the number of “reprocessing” cycles that are possible with the BiTEMPS methacrylate dynamic crosslinker before competitive oxidative permanent crosslinking occurs include visual observation. Formed film that is mechanically deformed is heated to the reprocessing temperature and is visually inspected to determine whether the mechanically deformed film heals to form a stable film.

The present disclosure provides a process. In an embodiment, the process includes heating a foam article to a reprocessing temperature. The foam article is composed of a crosslinked foam composition composed of (i) an ethylene-based polymer and/or a polar ethylene-based polymer, (ii) linkages of Structure 2 (formed from 2,2,6,6-tetramethyl-4-piperidyl methacrylate disulfide (BiTEMPS methacrylate)), and (iii) optional additive(s). The process includes forming, at the reprocessing temperature, the foam article into a re-processable polymer composition (a re-processable ethylene-based polymer or a re-processable polar ethylene-based polymer). The process includes shaping, at the reprocessing temperature, the re-processable polymer composition (re-processable ethylene-based polymer composition or the re-processable polar ethylene-based polymer composition) into a re-processed pre-form. The process includes cooling the re-processed pre-form to below the reprocessing temperature and forming a second article composed of a re-crosslinked polymer composition composed of (i) the ethylene-based polymer and/or the polar ethylene-based polymer and (ii) linkages of Structure 2 (formed from the BiTEMPS methacrylate).

The second article may be the same as, or different than, the first article.

In an embodiment, the shaping step is a procedure selected from the group consisting of injection molding, extrusion molding, thermoforming, slushmolding, over molding, insert molding, blow molding, cast molding, tentering, compression molding, and combinations thereof.

Nonlimiting examples of suitable articles (second article) for the present re-crosslinked (polar) ethylene-based polymer (with BiTEMPS methacrylate) composition include foam article, elastic film; elastic fiber; soft touch good, such as tooth brush handles and appliance handles; gaskets and profiles; three dimensional loop material; coating for conductors; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

Another embodiment of provides a reprocessing foamed article process. In an embodiment, the reprocessing includes converting the foam into small pieces, mixing optional additives into the small pieces, heating the mixed product to a reprocessing temperature or combination of above methods. The converting process comprises pressing, calendaring, cutting, shearing, or combination of above process at low temperature, room temperature, or elevated temperature. The foam composition composed of (i) an ethylene-based polymer and/or a polar ethylene-based polymer, (ii) linkages of Structure 2 (formed from 2,2,6,6-tetramethyl-4-piperidyl methacrylate disulfide (BiTEMPS methacrylate)), and (iii) optional additive(s). The process includes cooling the re-processed pre-form to below the reprocessing temperature and forming a second article composed of a re-crosslinked polymer composition composed of (i) the ethylene-based polymer and/or the polar ethylene-based polymer and (ii) linkages of Structure 2 (formed from the BiTEMPS methacrylate).

By way of example, and not limitation, some embodiments of the present disclosure will now be described in detail in the following examples.

### 1. Materials

Materials used in the comparative samples (CS) and inventive examples (IE) are provided in Table 1 below.

TABLE 1
Materials

| Name | Structure/properties | Source |
|---|---|---|
| INFUSE ™ 9000 | Ethylene/octene multi-block copolymer | The Dow Chemical |
| | d - 0.877 g/cc, MI 1 g/10 min | Company |
| Elvax 265 | Ethylene vinyl acetate | The Dow Chemical |
| | d - 0.951 g/cc, MI 3.0 g/10 min | Company |
| BiTEMPS methacrylate | 2,2,6,6-tetramethyl-4-piperidyl methacrylate disulfide | Custom synthesis |
| Crosslinker (“BiTEMPS”) | C₂₆H₄₄N₂O₄S₂ (Structure 1) | |
| | 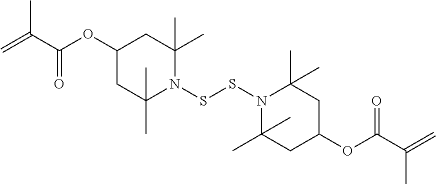 | |
| Dicumyl Peroxide (“DCP”) | C₁₈H₂₂O₂ | Sinopharm |
| Radical initiator | | |
| BIPB (pure) | C₆H₄[C(CH₃)₂OOC(CH₃)₃]₂ | ARKEMA |
| Radical initiator | Bis(t-butylperoxy Isopropyl)benzene (“BIBP”) | |
| | 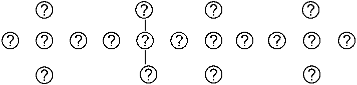 | |
| AC-9000 | Azodicabonamide type blowing agent | Sinopharm |
| ZnO | Zinc oxide | Sinopharm |
| HSt | | Sinopharm |
| ZnSt | Zinc stearate | Sinopharm |
| Talc | | Sinopharm |
| TiO₂ | Titanium dioxide | Sinopharm |

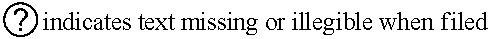

### 2. Synthesis of BiTEMPS Methacrylate

To synthesize BiTEMPS methacrylate, 2,2,6,6-tetramethyl-4-piperidyl methacrylate (8.78 g, 39.0 mmol, supplied by TCI America) is first dissolved in anhydrous petroleum ether (^{˜}90 mL, supplied by Sigma-Aldrich, dried over molecular sieves for 48 hr before use) and cooled to −70° C. in a dry ice/acetone bath. Afterward, sulfur monochloride (1.30 g, 9.7 mmol, supplied by Sigma-Aldrich) is dissolved in anhydrous petroleum ether (^{˜}1.25 mL) and added dropwise to the reaction vessel over the course of 30 minutes. The solution is stirred at −70° C. for an additional 30 minutes and at room temperature for 15 minutes. Next, BiTEMPS methacrylate is precipitated out by pouring the reaction solution into copious distilled water and stirring at room temperature overnight. The precipitates are collected, vacuum-filtered, and vacuum-dried at 60° C. for 48 hr to obtain BiTEMPS methacrylate, shown as Structure 1 below.

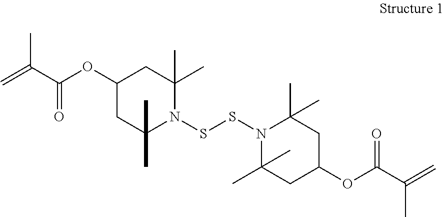

### 3. Formulations—Crosslinkable Compositions

### A. Inventive Examples

INFUSE 9000 (or EVA 265), dicumyl peroxide, and BiTEMPS methacrylate were combined (in the amounts shown in Table 2 below) and batch mixed at 100° C. Properties are provided in Table 2 below.

### B. Comparative Samples

400 g of INFUSE pellets and 4 g of DCP powder were loaded into the PTFE bottle. This bottle was sealed and lay on the roller with 65 RPM rolling speed. This roller is then transferred into 55° C. hot air oven for 2 h. After reaching the desired time, the roller was stopped, and the bottle was transferred from the oven and cooled down at room temperature.

After mixing, each formulation was transferred to a 172 mm×172 mm×7 mm mold. The mold was further put into a hot press. After pre-heating hot press at 125° C. for 3 minutes followed by degassing 8 times, this mold was transferred to a second hot press at 180° C. In the second hot press, the mold was pressed at 180° C. and 280 kiloNewtons (kN) pressure for 10 minutes curing and then cooled down to 45° C. The pressure was then removed, forming crosslinked compositions. Each crosslinked composition was fed into an autoclave equipped with a heating unit and gas injection valve. The autoclave was heated to desired temperature (120-150° C.). At the same time, the blowing agent was injected into the autoclave for saturation (0.5^{˜}2 hours). The autoclave pressure varied depending on the polymer type. The autoclave pressure is from 50 bar to 200 bar. After the crosslinked composition was saturated with blowing agent, a fast depressurization occurred and foam buns were prepared. The foamed buns were conditioned at room temperature for 24 h. Corresponding performance are summarized in Table 2.

TABLE 2
Formulations

| | CS-1 | CS-2 | IE-A* | IE-B* | IE-1 | IE-2 | CS-3 | IE-3 |
|---|---|---|---|---|---|---|---|---|
| Elvax 265 | 100 | 100 | 100 | 100 | 100 | 100 | | |
| INFUSE 9000 | | | | | | | 100 | 100 |
| BIPB (pure) | 0.45 | 0.55 | | | 0.55 | 0.55 | — | — |
| DCP | — | — | 1.0 | 1.0 | — | — | 1 | 1 |
| BiTEMPS | 0 | 0 | 5.0 | 2.5 | 2.5 | 5 | 0 | 5 |
| Cellcom ACIT | | | 2.5 | 2.5 | | | | |
| AC-9000 | 2.5 | 2.5 | — | — | 2.5 | 2.5 | | |
| ZnO | 1.5 | 1.5 | 1.5 | 1.5 | 1.5 | 1.5 | | |
| HSt | 0.5 | 0.5 | | | 0.5 | 0.5 | | |
| ZnSt | 0.5 | 0.5 | 0.5 | 0.5 | 0.5 | 0.5 | | |
| Talc | 5 | 5 | 5 | 5 | 5 | 5 | | |
| TiO2 | 2 | 2 | 2 | 2 | 2 | 2 | | |
| Total (phr) | 112.45 | 112.55 | 117.5 | 115 | 115.05 | 117.55 | 101 | 106 |
| Foam | CS1-foam | CS1-foam | IE-A-foam | IE-B-foam | IE1-foam | IE2-foam | CS3-foam | IE3-foam |
| properties | | | | | | | | |
| Density (g/cc) | | | 0.155 | 0.132 | | | 0.1544 | 0.1248 |
| Rebound (%) | | | 53 | 52 | | | 74 | 72 |
| Tensile (MPa) | | | | | | | 2.16 | 2.56 |
| Hardness | | | 36 | 34 | | | 54 | 45 |
| (Asker C) | | | | | | | | |
| Compression | | | | | | | 16.4 | 26.7 |
| set (%) | | | | | | | | |

*IE-A/IE-B each were pre-molded at 80° C. for 10 min to fill the shape of the square mold (1.517 in × 1.517 in × 0.246 in); composition was then held at 180° C. for 20 min at 40,000 lbs force, mold pressure was released and foam jumped from mold.

### 4. Re-Processability

A. Select crosslinked compositions in Table 2 were tested for re-processability. Crosslinked compositions were cut into small pieces by hand using scissors. The small pieces were transferred to a mold with 120 mm×75 mm×3 mm size and re-processed under different temperatures under 280 KN pressure for 10 minutes. Results are reported in Table 3 below.

TABLE 3
Re-processability

| | Comparative samples - not re-processible | | | Inventive Examples - re-processible | |
|---|---|---|---|---|---|
| | CS-3 | CS-3 | IE-3 | IE-3 | IE-3 |
| | Reprocess180 | Reprocess250 | Reprocess130 | Reprocess180 | Reprocess250 |
| Re-process | 180 | 250 | 130 | 180 | 250 |
| temperature | | | | | |
| (° C.) | | | | | |
| Result | Not | Not | Not | Reprocessable | Reprocessable |
| | reprocessable | reprocessable | reprocessable | | |

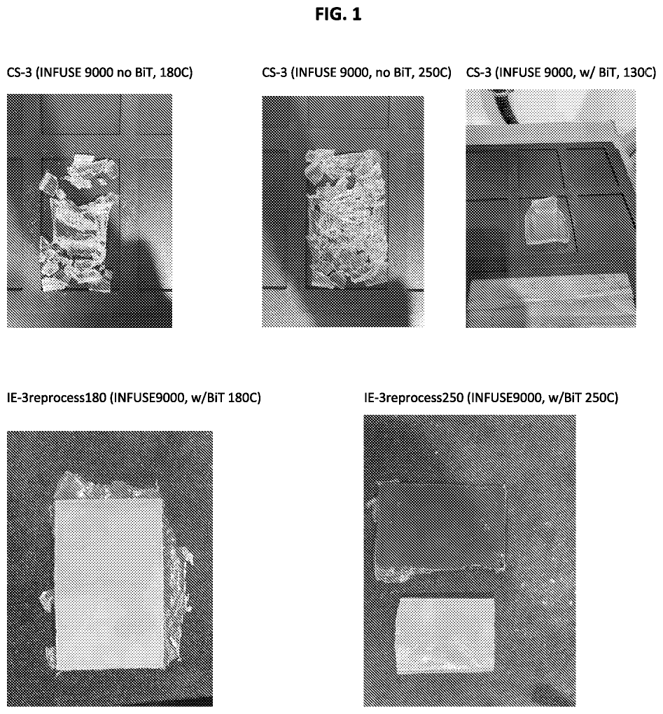

FIG. 1 shows photographs of the non-reprocessable comparative samples: CS-3 Reprocess180, CS-3Reprocess250, and IE-3 Reprocess130. FIG. 1 shows photographs for re-processable examples, IE-3 Reprocess180 and IE-3 Reprocess250.

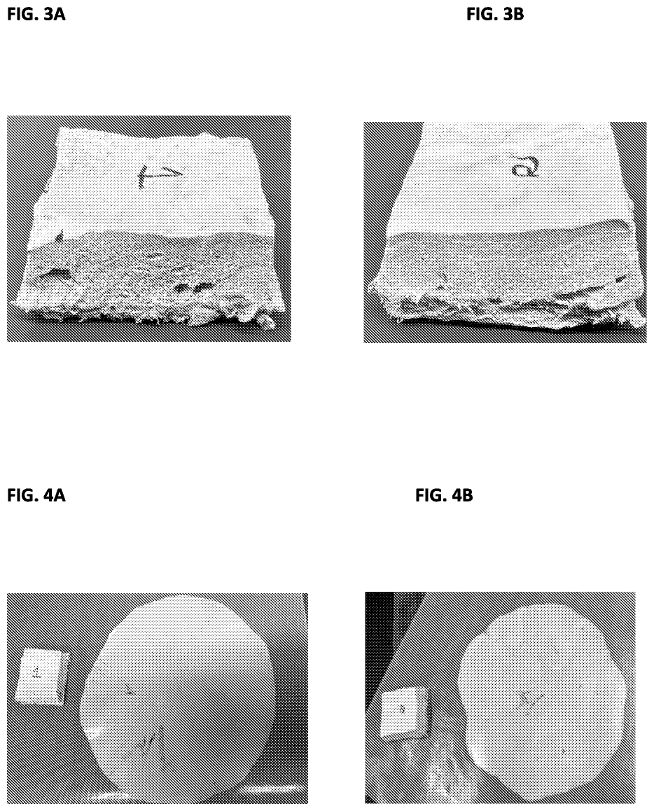

B. FIG. 3A and FIG. 3B are photographs each showing respective IE-A-foam and IE-B-foam. IE-A-foam and IE-B-foam each were cut into small pieces by hand using scissors. The small pieces were transferred to a mold and compression molded at 180° C. for 2 minutes at 40,000 psi. FIG. 4A and FIG. 4B show respective IE-A-foam and IE-B-foam each as a re-processed uniform compression molded disc, thereby showing IE-A-foam and IE-B-foam each is completely re-processable.

### 5. Preparation of Recycled Foams

Re-processed compositions (from Table 3) were foamed under the same condition as described in Paragraph [0096] The properties of foams are provided in Table 4 below.

TABLE 4
Foams

| | Starting composition | | | |
|---|---|---|---|---|
| | CS-3 | IE-3 | IE-3 | IE-3 |
| | Foam name | | | |
| | CS-3 foam | IE-3 foam | IE-3reprocess180 foam | IE-3reprocess250 foam |
| Density (g/cc) | 0.1544 | 0.1248 | 0.1149 | 0.0581 |
| Rebound (%) | 74 | 72 | 77 | 70 |
| Tensile (MPa) | 2.16 | 2.56 | 2.62 | 1.03 |
| Hardness (Asker C) | 54 | 45 | 55 | 16 |
| Compression set (%) | 16.4 | 26.7 | 22.0 | 85.9 |

*IE-A foam compression molded at 180° C. for 2 min at 40,000 psi

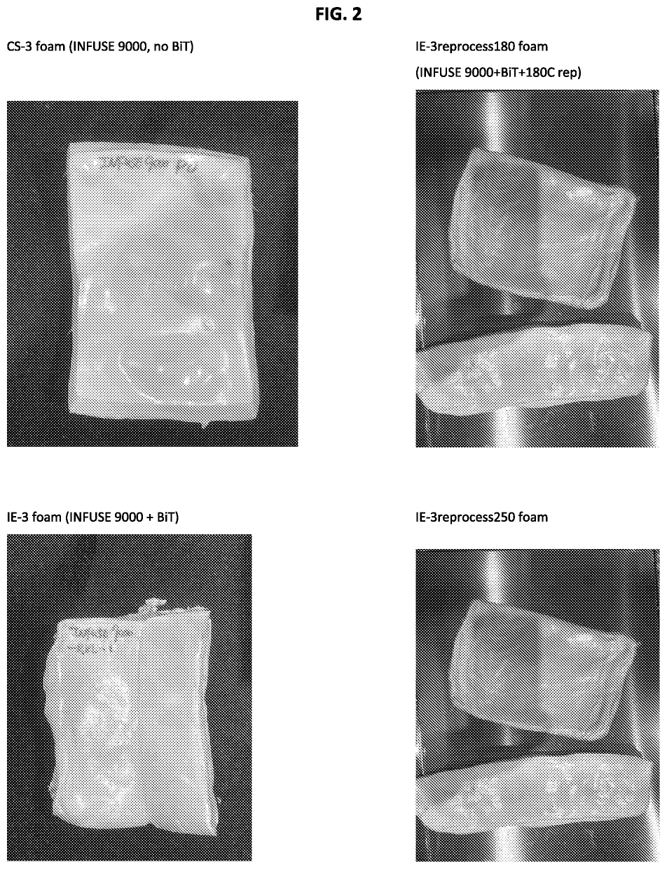

FIG. 2 shows photographs of foams: CS-3 foam, IE-3 foam, IE-3reprocess180 foam, and IE-3reprocess250 foam.

It is specifically intended that the present disclosure is not limited to the embodiments and illustrations contained herein, but include modified forms of those embodiments including portions of the embodiments and combination of elements of different embodiments as come within the scope of the following claims.

1. A foam article comprising:
a crosslinked foam composition formed from starting materials comprising
a polymer selected from the group consisting of an ethylene-based polymer, a polar ethylene-based polymer and combinations thereof; and
2,2,6,6-tetramethyl-4-piperidyl methacrylate disulfide (BiTEMPS methacrylate).

2. The foam article of claim 1 wherein the crosslinked foam composition comprises
the polymer selected from the group consisting of an ethylene-based polymer, a polar ethylene-based polymer and combinations thereof; and
linkages having a Structure (2)

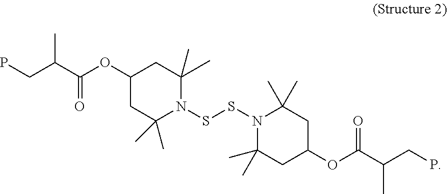

3. The foam article of claim 1 wherein the polymer is an ethylene-based polymer.

4. The foam article of claim 3 wherein the ethylene-based polymer is an ethylene/α-olefin multi-block copolymer.

5. The foam article of claim 4 wherein the crosslinked composition is formed from starting materials comprising:
from 50 wt % to 99 wt % of the ethylene/α-olefin multi-block copolymer; and
from 1 wt % to 15 wt % of the BiTEMPS (methacrylate).

6. The foam article of claim 2 wherein the polymer is a polar ethylene-based polymer.

7. The foam article of claim 6 wherein the polar ethylene-based polymer is ethylene vinyl acetate.

8. The foam article of claim 7 wherein the crosslinked composition is formed from starting materials comprising
from 50 wt % to 99 wt % of the ethylene vinyl acetate; and
from 1 wt % to 15 wt % of the BiTEMPS (methacrylate).

9. The foam article of claim 1, wherein the foam article has a property selected from the group consisting of
a density from 0.05 g/cc to 0.3 g/cc,
a tensile strength from 0.7 MPa to 4 MPa,
a rebound from 40% to 90%,
a hardness (Asker C) from 5 to 60, and
combinations thereof.

10. A foam article comprising:
a crosslinked composition comprising
a polymer selected from the group consisting of an ethylene-based polymer, a polar ethylene-based polymer and combinations thereof; and
linkages having a Structure (2)

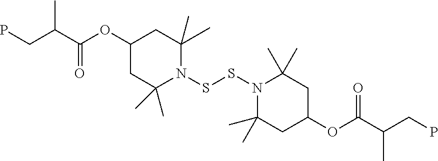

11. A process comprising:
heating a foam article to a reprocessing temperature, the foam article composed of a crosslinked composition comprising
(i) a polymer selected from the group consisting of an ethylene-based polymer, a polar ethylene-based polymer and combinations thereof; and
(ii) linkages having a Structure (2) 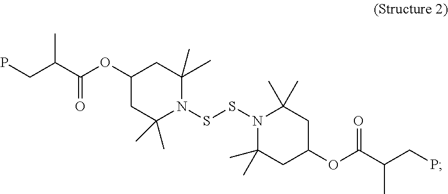
forming, at the reprocessing temperature, the foam article into a re-processable polymer composition;
shaping, at the reprocessing temperature, the re-processable polymer composition into a re-processed pre-form;
cooling the re-processed pre-form to below the reprocessing temperature; and
forming a second article composed of a re-crosslinked polymer composition composed of
(i) a polymer selected from the group consisting of the ethylene-based polymer, the polar ethylene-based polymer and combinations thereof; and
(ii) linkages having the structure (2).

12. The process of claim 11 wherein the polymer is an ethylene-based polymer.

13. The process of claim 11 wherein the polymer is a polar ethylene-based polymer.
